(19) United States
(12) Patent Application Publication
(10) Pub. No.: US 2020/0394531 A1
(43) Pub. Date: Dec. 17, 2020

(54) HANDLING OF DISTRIBUTED LEDGER OBJECTS AMONG TRUSTED AGENTS THROUGH COMPUTATIONAL ARGUMENTATION AND INFERENCE IN THE INTEREST OF THEIR MANAGERS

(71) Applicant: VALORSEC SA, Paradiso (CH)

(72) Inventors: Alberto Rigotti, Milano (IT); Davide Lenzarini, Adliswil (CH); Claudio Roberto Boër, Carona (CH)

(73) Assignee: VALORSEC SA, Paradiso (CH)

(21) Appl. No.: 16/437,139

(22) Filed: Jun. 11, 2019

(51) Int. Cl. G06N 5/04; H04L 9/32

(52) U.S. Cl. CPC G06N 5/04; H04L 9/32

(57) ABSTRACT

A method and system for the handling of distributed ledger objects among trusted agents through computational argumentation and inference in the interest of their managers, whereto a trusted agent, the protagonist, after a selection and identification phase, initiates a dialogue with other trusted agents, the antagonists, proposing an argument to justify the acceptance of a claim aiming to obtain the handling of distributed ledger objects in the interest of its manager. The antagonists may or may not decide to be engaged in a negotiation with the protagonist depending on their claims with their given constraints and limits. In the former case they exchange arguments and counterarguments with the other trusted agents involved and through computational argumentation and inference they may agree on the handling of distributed ledger objects by subscribing a contract and performing it in a distributed ledger. Each agent is unequivocally associated to its manager and each agent has a root of trust module allowing an unequivocal identification of it as trusted.

### BACKGROUND

### 1. Field of the Invention

The technology evolution in our measured time (4 million years) has been slow compared with the recent evolution particularly in the computer science (merely 60 years). The development of artificial intelligence is the most challenging of all the computer science and technology fields and big steps forward have been made but still much remains to be done. At the acquired maturity level in big data and analytics fields, don't corresponds an equivalent evolution in machine learning and, in general, in semantic computing. The present invention aims to help the advancement in particular in the innovation of data organization and management and of security management and in the frontier of meaning centric computational semantic, where there is still not much realized and the traditional formal logic-based computing don't represents the right way.

The present invention is a computing science and engineering development, in the field of human to machine and machine to machine interaction, focusing in the area of computational argumentation and inference, strongly integrated with root of trust based security and distributed ledger technology and solutions, that is still not realized.

### 2. Background Art

In the present invention, distributed ledger technology that operates with no central authority and no arbitrator is widely applied and each node that proceeds to the registration and storage, works independently. Distributed ledger technology can be used in public mode, in decentralized system of trust, and the transactions occur between any two parties, from any computer, at any location; the private mode is used more as a database than as something to be openly traded and agreed upon; transactional value is reliant on the private party and the data structure is decentralized but it can be controlled by the owner of the network; the hybrid mode of public and private structures, consortium, relies on consensus just as public does and assigns permissions on which nodes have the authority to approve which transactions, like private does. This combination allows the technology to manage any combination of private or public as the consortium agrees. In the present invention many different data structures and consensus methods of distributed ledger technology may be applied depending on application needs and, in any case, combined with computational argumentation and inference and with root of trust based security. Some examples of distributed ledger data structure and consensus methods are Blockchain, Tangle, Tempo and IOST. Consensus methods are employed to allow all actors in the network to come to general agreement on what the true information is, the majority of the network agreeing on the information presented.

The Blockchain data structure uses an electronic ledger of transactions held by multiple computers and applying both consensus methods, the most popular proof of work, as in Bitcoin and Ethereum, and proof of stake, as EOS and Tron: proof of work disincentives bad actors because of the tremendous power/electricity that would be consumed (at their cost) and proof of stake disincentives bad actors by making them risk their own wealth. The World Bank Distributed Ledger Technology and Blockchain Report on April 2018 presents the state of the art of distributed ledger technology applying Blockchain data structure and consensus methods (World Bank, Apr. 12 2018, Report 122140 V.1).

The Tangle is a data structure more recent solution that offers the benefits of Blockchain with better performance utilizing the mathematical directed acyclic graph that travels in one direction without cycles connecting the other edges; this means that it is impossible to traverse the entire graph starting at one edge and the edges of the directed graph only go one way. A transaction cannot loop back on itself after linking to another transaction. The Tangle method of reaching consensus allows multiple transactions to be verified simultaneously; this is simpler and more flexible than the classic Blockchain technique of bundling transactions into blocks that can only be validated in a rigid, linear way, one block at a time, spending a trivial amount of computational power. An example of Tangle distributed ledger is IOTA in which each new transaction must validate at least two previous transactions before it can be validated. An algorithm in IOTA ensures the random selection of transactions for verification, effectively preventing network members from only validating their own transactions (The Tangle, 30 Apr. 2018, v. 1.4.3 IOTA Academic Papers).

The Tempo consensus method don't utilize proof of work neither proof of stakes, but Temporary proof, using “logical clocks” to achieve proper ordering of events that take place in the entire network. A logical clock is essentially an ever-increasing integer value, that increases each time it witnesses an event. In Tempo, participants (nodes) increment their logical clock only when they witness an event that they haven't witnessed before. Achieving proper ordering of events is essential to prevent bad actors from malicious transactions. An application of Tempo consensus method is Radix (Radix—Tempo Whitepaper, 25 Sep. 2017).

The IOST introduced a “Proof-of-Believability” consensus algorithm enabling a high transaction throughput while ensuring nodes stay compliant, using factors including IOST token balance, reputation-based token balance, network contributions and user behaviours.

In the present invention the contract negotiation is based not only on right management terms and conditions but also on manager needs and behaviour and demand/offer relationship, particularly on pricing policies definition. The contract definition is dynamic and start from a utilized and updated contract template repository. Recently some useful models in the analysis of legal decision making are emerging, including what-if questions and the analysis of alternative conclusions as modelling of a public prosecution, charging decision as part of a real legal decision making case study containing many argumentations (A neural cognitive model of argumentation with application to legal inference and decision making, Journal of Applied Logic Volume 12, Issue 2, June 2014, Pages 109-127). The MATRIX tool allows to use natural languages to directly implement smart contracts in business. MATRIX neural networks will generate a library of templates based on initial inputs, that are then automatically refined and evolved based on historical data. MATRIX proposes an innovative proof of work and proof of stake structure, dynamically selecting a delegation network, in which all nodes are voted as delegates of others (MATRIX Technical Whitepaper, 23 Apr. 2018). In the present invention the contract negotiation and subscription are based on computational argumentation and inference, with root of trust based security in distributed ledger data structures.

The Swiss Federal Control Authority FINMA classified crypto-objects in payment, utility, asset and hybrid. Payment tokens, or cryptocurrencies, are tokens used, as a means of payment for acquiring goods or services or as a means of money or value transfer. Utility tokens are intended to provide access digitally to an application or service by means of a Distributed Ledger based infrastructure. Asset tokens represent debt or equity claim on the issuer analogous to equities, bonds or derivatives or tokens which enable physical assets to be traded. Utility and Asset tokens can also be classified as payment tokens (referred to as hybrid tokens). (FINMA Guidelines for enquiries regarding the regulatory framework for initial coin offerings, 16 Feb. 2018). The present invention analyses different Swiss Regulatory kinds of valorised crypto-objects and addresses them to specific external management and exchanging platforms.

The distributed ledger technology can be also applied to verify credentials, certificates and records. Open standards like Blockcerts, based on prototypes developed at the MIT Media Lab, are available to create and verify blockchain-based records for academic credentials, professional certifications, workforce development, and civic records. The open standard ensures the longevity and interoperability of digital records. The present invention is using such open standards and integrates them with advanced conversational argumentation to enlarge the field of applications.

Current computational inference is based on formal logic and data association, very powerful for analytics and big data. In the natural language processing, in machine learning, in speech and speaker recognizing the computational inference shows lacks and weaknesses. Many modern natural language processing systems rely on the ability to predict semantic relatedness of two words. But natural language often involves multi-word expressions, whose meaning cannot be inferred from their constituents. Natural language processing (NLP) describes the automatic understanding, interpretation and manipulation of human language (such as speech and text) by computers. NLP is a key factor in interactions between humans and machines. With “word by word” computational inference approaches the risk of malicious intent can be more and more serious.

Computational argumentation considers the cause/effect principle and not data association as computational inference and is based on argumentation theories founded by Aristotelian Topic and strongly developed around 1950; a fundamental text is the Handbook Argumentation Theory (Springer References, 2014 ISBN 978-90-481-9474-2). Several universities and research centres started the effort to model argumentation process; the Argumentation Method Theory (AMT) represents one of the most relevant effort to define a methodology to model argumentative contents (Springer, ISBN 978-3-030-04566-1). Thanks to these theoretical efforts, now computational argumentation is becoming a scientific discipline (Five Years of Argument Mining: a Data-driven Analysis, Proceedings of the Twenty-Seventh International Joint Conference on Artificial Intelligence IJCAI-18). Computational argumentation is based on argumentation theory that provides a powerful mechanism for dealing with incomplete and possibly inconsistent information and for the resolution of conflicts and differences of opinion amongst different counterparts. Computational argumentation aims at providing methods and systems for various kinds of argumentation-based decision-making that generate automatically transparent and rational decisions. In the present invention computational argumentation can support several aspects of decision-making and critical thinking (needing to evaluate pros and cons of conflicting decisions) or it can be used by multiple agents dialectically engaged to come to mutually agreeable decisions (needing to assess the validity of information the entities become aware of and resolve conflicts), especially when decisions need to be transparently justified. Computational argumentation process identifies and represents argument structures such as automated logical reasoning regarding defeasible reasons both suppositional reasoning and on resource-bounded reasoning, normative reasoning and modelled practical reasoning.

The computational argumentation is based on formalized argumentation schemes and modelling degrees of justification. The semantics of argumentation clearly separates attack and defeat about defeasible reasoning and about the strength of defeasible arguments. With computational inference only, potential users of existing argumentation-based decision-making methods are supported and empowered, but lack either means of formal evaluation sanctioning decisions as (individually or collectively) rational or a computational framework for supporting automation. Some details and practical examples about computational argumentation can be found in “An argumentation reasoning approach for data processing” by Karafilia, Spanakib, Lupua (2017) and in “Algorithms for computational argumentation in artificial intelligence” by v. Efstathiou (2010).

The Inference computing, as machine learning and analytics and other digital and artificial intelligence methods and systems focused on data association, can be integrated with computational argumentation. Computational inference is based on formal logic and in the last decade argumentation has attracted wide interest in computing to understand and meet the challenges of a number of applications characterised by the lack of certain, consistent and complete information, even numerical (e.g. statistical) information. The relationships between computational argumentation with formal logic can be synergic, starting from knowledge representation and reasoning, including abductive logic programming and non-monotonic reasoning argumentation frameworks, using natural language processing and machine learning. Since 2014, the IBM Project Debater team has released a consistent set of technical papers and benchmark datasets across multiple research domains, with several more publications pending. A major obstacle in developing automatic argumentation mining techniques was the scarcity of relevant high-quality annotated data. IBM developed the first dataset to address this need. It includes 2,683 argument elements, collected in the context of 33 controversial topics, organized under a simple claim-evidence structure. To train a Deep Neural Network (DNN) to predict thematic similarity between sentences, IBM automatically created a weakly labeled dataset of sentence triplets (a pivot sentence from a Wikipedia page, another sentence from the same section of the article, and a third sentence from a different section of the article). The IBM model, trained over these data, outperformed state-of-the-art methods (Annotated argument elements and Identifying similar sentences ACL, 2018). In the last period the first argumentation macro-language and argumentation tools are emerging; in order to address these shortcomings, alternatives technologies like Computer Supported Argumentation Tools (CSAV), able to support a more structured knowledge and conflicting points of views representation, have been developed (ISBN 978-1-85233-6). Other researches focus on argumentation tools (Springer, ISBN 978-1-85233-664).

Business and social interactions are complicated, messy and nuanced and the computational inference is still far away from understanding that. Today the computational inference is not able to evaluate the truthfulness of statements, it can only detect signals like expressions of disbelief in a comment. Satire for instance, often used in human interactions, is one of the toughest problems for computational inference systems trying to identify false content. This is the reason why the present invention applies the best solutions of computational inference technology integrating with computational argumentation.

The need of computational argumentation is particularly evident in vocal interactions when the debating system needs to understand in real time arguments made by its opponent. Vocal argumentation is in cases of face-to-face spoken interaction under different conditions of turn-taking; vocal argumentation is one of the oldest activities that man has engaged. Vocal computational argumentation and inference is emerging as the most critical factor of vocal assistant technology implementation; it is evident that even if speaker recognizer, voice recognizer, translators, navigators and machine learning and analytics are migrating under vocal assistant technology, the human machine vocal dialog and machine to machine sound interaction needs an upgrade in term of argumentation reasoning consistency (Knowledge sharing VS construction in online-conversations: a Debate Dashboard to support distributed decision making through the collaborative construction of shared knowledge representation—2011, 10.6092/UNINA/FEDOA/8904). Identity perception from vocal signals human voices are extremely variable: the same person can sound very different depending on whether they are speaking, laughing, shouting or whispering. In order to successfully recognise someone from their voice, a listener needs to be able to generalize across these different vocal signals. Vocal argumentation facilitates the understanding of voice-identity processing by controlling the essential characteristic of each person argumentative behaviour. The current vocal assistants essentially based on computational inference often do not perform well when argumentation between counterparts is involved. Example are Ski, Alexa, Google Home and so on. The ArgueApply allows users to participate in online debates and to analyse these discussions as well as their inherent viewpoints revealed by argumentation semantics (ArgueApply: A Mobile App for Argumentation—supported by the German Research Foundation (DFG) under grant BR 1817/7-2). In the present invention the vocal argumentation is based on computational argumentation and integrates computational argumentation and inference with root of trust based security in distributed ledger technology.

The Trusted Computing Group (TCG) (IIoT World, 2018) developed specifications that have become the standard for securing devices, data and identity, including the Trusted Platform Module (TPM) for personal computers, laptops and other similar devices. Global Platform developed the standards for the Trusted Execution Environment (TEE) (2018 GlobalPlatform, Inc., May 2018), which is a vault of sorts that lives inside the hardware of a mobile phone, tablet and other related devices. The TEE is isolated from the normal operating system of the device, and so can execute code that can't be seen by that OS. It is also rooted in the hardware, in a root of trust, to guarantee a secure execution environment. A root of trust is a source that can be unconditionally considered trusted within a cryptographic system and it generally includes a hardened hardware security module (HSM) which generates and protects keys and performs cryptographic functions like data encryption/decryption data and digital signatures generation/verification within its secure environment. A root of trust is immune to software attack and ideally most hardware attacks. A root of trust serves as separate computing engine, controlling the trusted computing platform and cryptographic processor on device is embedded in. Cryptographic secrets are applied as unique keys, based on root of trust using, for instance, fuzzy extractor algorithms. Biometric security evaluates an individual's bodily elements or biological data, including fingerprints, eye texture, voice, hand patterns and facial recognition. A root of trust safeguards the security of data and applications and helps to build trust in the overall ecosystem. In particular, it enables connected devices to securely and uniquely identify and authenticate themselves to create secure channels for remote device management and service deployment.

One of the biggest challenges for the Internet of Things (IoT) is to deal with the fragmented trust domains. The traditional model is based on a security paradigm that does not fit well with the heterogeneous IoT ecosystem where constrained devices belong to independent administrative domains. A distributed trust model for the IoT that leverages the existing trust domains and bridges them to create end-to-end trust between IoT devices relying on their root of trust is a new way. Some new cryptographic primitive, denoted as obligation chain designed as a credit-based distributed ledger technology with a built-in reputation mechanism, have also been developed. Its innovative design enables a wide range of use cases and business models that are simply not possible with current distributed ledger technology based solutions while not experiencing traditional Blockchain delays.

New solution like the Rivetz Network (The Rivetz Company, 2018), simplify and enhance a user's digital experience. It moves trust from the servers to the powerful devices we use to access digital services. With its combination of Blockchain technology and the hardware-based trusted computing capabilities already built into millions of devices, such technologies verify the intent of every transaction.

The definitive social impact of the distributed ledger technology will depend on who will have control of our digital identity that is why the root of trust and its univocal association to its owner is fundamental. At the same time, it is more and more evident that the relevance of the counterparts involved in distributed ledger applications as human, robots and internet of things devices, requires a stronger protection of privacy, security and safety.

An embodiment of the present invention considers the possibility to activate a not human agent that performs the distributed ledger objects valorisation phase if the contract outcome of the negotiation is subscribed with a human agent. For example, a similar approach is taken in the Amazon Mechanical Turk, MTurk (Requester, HIT—Human Intelligent Task, Worker, Assignment, Reword), a crowdsourcing marketplace that makes it easier for individuals and businesses to outsource their processes and jobs to a distributed workforce who can perform these tasks remotely. This could include anything from conducting simple data validation and research to more subjective tasks like survey participation, content moderation, and more. MTurk enables companies to harness the collective intelligence, skills, and insights from a global workforce to streamline business processes, augment data collection and analysis, and accelerate machine learning development. Crowdsourcing is a good way to break down a manual, time-consuming project into smaller, more manageable tasks to be completed by distributed workers over the Internet (also known as ‘microtasks’). In comparison with the human agent involvement in the present invention, the Mechanical Turk isn't computational argumentation based, nor root of trust based, nor distributed ledger managed (Systems Perspective of Amazon Mechanical Turk for Organizational Research: Review and Recommendations, Melissa G. Keith, Louis Tay and Peter, D. Harms; Front Psychol. 2017; 8: 1359).

In current background state of the art, the combined usage of distributed ledger and computational argumentation and inference is not available as well as the combined usage of computational argumentation and inference and root of trust based security, the core of the present invention, is not available. The crypto-object value generated by the invention application justifies the combined usage of distributed ledger and computational argumentation and root of trust based security; in fact, it is necessary to protect in distributed ledger, negotiated, contractualised and valorized crypto-objects values as utility, security and assets, generated through computational argumentation and inference. The security and authorization functions based on cryptographic secrets and biometric parameters sometimes are not sufficient to protect the user. At the same time, the user is characterized by a specific argumentation behavior. For this reason, in the present invention the computational argumentation can be applied also to identify the argumentation profile of the manager.

Furthermore, consistency and relevance of the contents generated by computational argumentation and inference must be managed with strong, secure and transparent distributed ledgers and the involved counterpart must be more and more protected; in the perspective, the partial usage of the distributed ledger and computational argumentation and root of trust based security components will be unjustified otherwise the risk will become unmanageable. In conclusion of background state of the art analysis, once the above areas are integrated, then it is necessary to bring all together under a unified method and technology. At present, to our knowledge, no such integration has been realized and the core of the present invention lies precisely on this generalized integrated method and developed technology.

### SUMMARY

The invention is characterized by the combined and integrated application of the following method steps and by the specific modules present in the system.

In the present description, the word “claim” is used in connection with a claim definition module and the related activities as having the meaning of “request” or “assertion”.

A method according to the invention is described in claim 1.

A system according to the invention is described in claim 13.

The management of a claim is solved obtaining a distributed ledger object; the claim manager is associated with an unequivocally identified agent, the protagonist, in charge of the claim development and that will operate with other agents, the antagonists, in the interest of its manager. The managers can be human, animal and any proactive machine while the agents can be computerized entities as computers, robots and IoT devices or humans. The connection between the agent and its manager could be based on vocal interactions. To achieve a very high security level, the manager could be authenticated through biometrics and/or behavioural parameters and/or computational argumentation and inference by using and enriching knowledge models available in a dedicated repository; so that the manager acquires an unequivocal identification as trusted.

Each agent executes an application to obtain the claim defined by the manager with its given constraints and limits. This application could be selected from a dedicated application repository.

When appropriate, considering the claim's given constraints and limits, an agent, the protagonist, initiates the claiming process by selecting the antagonists and by establishing a connection with the selected antagonists once agreed with them on the channel to be used. The connection between the agents could be based on vocal interactions.

Before to proceed further, the connected agents authenticate each other by generating cryptographic secrets, derived from each agent root of trust module, and by exchanging them in order to allow an unequivocal identification of all the agents connected as trusted.

After the agents identification, the trusted protagonist generates arguments to justify the acceptance of its claim in the interest of its manager and sends them, initiating a dialogue, to the connected trusted antagonists.

Each connected trusted antagonist verifies the compliance of the trusted protagonist's arguments with its claim, within its given constraints and limits, in order to decide on its engagement in a negotiation with the trusted protagonist and so, if positive, becoming a trusted engaged antagonist.

The trusted protagonist and the trusted engaged antagonists, through computational argumentation and inference, possibly using and enriching knowledge models available in a dedicated repository, exchange arguments and counterarguments in order to negotiate the handling of distributed ledger objects, required to obtain their claims.

If the negotiation converges to the handling of distributed ledger objects acceptable by them, the trusted protagonist and the trusted engaged antagonists accepting the deal subscribe a distributed ledger objects handling contract, possibly using and enriching contract models available in a dedicated repository.

The subscribed distributed ledger objects handling contract is performed in at least one distributed ledger to handle the negotiated objects.

In case some agents are humans, it is required that also at least one non-human agent participates in the claiming process as it is required to perform the subscribed distributed ledger objects handling contract in at least one distributed ledger in order to handle the negotiated objects

The present invention has a wide level of industrial applicability in the sectors in which high friendly, natural, argumentative and secure relationship between human to machine and machine to machine are necessary and pure computational inference and artificial intelligence are insufficient and/or inadequate.

The envisaged computational argumentation and inference, root of trust and distributed ledger methodology and systems will contribute to a sustainable society supported by the digital economy.

The present invention improves the quality of life in various contexts as home, work, city and for each negotiated claim generates micro-values and values managed by distributed ledger technology.

The invention application supports the daily human activity from working, movement, wellness, knowledge and entertainment, establishing a permanent, controlled and friendly relationship with the growing digitalised and robotized collaborative technology available around it.

The invention application is particularly useful in the frontiers of various industrial sectors of sharing economy as renewable energy community, near zero energy building, digital and autonomous mobility, km-zero production and distribution, mass production to mass customization. biotech, healthcare, agriculture, fintech, insurance, intellectual property and cultural asset management and entertainment media sectors, with a focus on sustainability, on circular economy and life cycle chains.

The invention application could increase efficiency and lower remittance costs, and potentially improve access to a wider population, who are currently outside the technology innovation.

In conclusion the invention introduces a novel trustable, autonomous, collaborative and meaning centered technology supporting the emerging sustainable circular economy, sharing society and natural environment.

Further characteristics and the advantages of the method and system according to the present invention will be apparent from the following description of an embodiment thereof, made with

reference to the annexed drawings, given for indicative and non-limiting purpose.

### BRIEF DESCRIPTION OF THE DRAWINGS/FIGURES

FIG. 1: Schematically shows, in a block diagram, the main components of the method and system for the handling of distributed ledger objects among trusted agents through computational argumentation and inference in the interest of their managers, according to the present invention.

FIG. 2: Schematically shows, in a block diagram, details about the main components of a protagonist agent, according to the present invention.

FIG. 3: Schematically shows, in a block diagram, that the protagonist and the antagonist agents, according to the method of the present invention, have the same main components. Anyway, when acting as protagonist the agent doesn't make use of the Argument Engagement module while when acting as antagonist the agent doesn't make use of the Antagonist Selection and the Argument Inception modules.

FIG. 4: Schematically shows, in a block diagram, additional optional components of an agent, protagonist or antagonist, according to the present invention.

FIG. 5: Schematically shows, in an activity diagram, the interactions among an agent (protagonist or antagonist) and its at least one manager for the definition of at least one claim with given constraints and limits to be obtained by executing at least one application.

FIG. 6: Schematically shows, in an activity diagram, additional details about the interactions among an agent (protagonist or antagonist) and its, at least one, manager focusing on the manager authentication phase and the application selection phase.

FIG. 7: Schematically shows, in an activity diagram, the establishment of a connection among the protagonist and the, at least one, antagonist selected during the antagonist selection phase. One of the potential antagonists is not selected in the example shown.

FIG. 8: Schematically shows, in an activity diagram, additional details about the interactions among the protagonist and the, at least one, antagonist selected during the antagonist selection phase focusing on the agents connection channel selection phase.

FIG. 9: Schematically shows, in an activity diagram, the agents identification phase, among the protagonist and, at least one, connected antagonist in order to trust each other, followed by the argument inception phase where the trusted protagonist generates at least one argument to justify the acceptance of its, at least one, claim and sends it to the, at least one, trusted antagonist that in turn via the argument engagement phase verifies the compliance of the, at least one, argument received with its, at least one, claim, within its given constraints and limits, in order to decide on its engagement in a negotiation with the trusted protagonist. One of the trusted antagonists don't engage in the example shown.

FIG. 10: Schematically shows, in an activity diagram, the interactions among the trusted protagonist and the, at least one, engaged antagonist via the generation and exchange of arguments and counterarguments in order to negotiate, with computational argumentation and inference, the handling of the distributed ledger objects required to obtain their claims within their given constraints and limits. One of the engaged antagonists doesn't find an agreement with the others in the example shown.

FIG. 11: Schematically shows, in an activity diagram, additional details about the interactions among the trusted protagonist and the, at least one, engaged antagonist focusing on the utilization of at least one computational argumentation and inference negotiation model selected from at least one negotiation models repository enriched with the arguments and counterarguments exchanged for the negotiation.

FIG. 12: Schematically shows, in an activity diagram, the interactions among the trusted protagonist and the, at least one, engaged antagonist that during the negotiation phase found an agreement to subscribe to at least one distributed ledger objects handling contract and to perform it in at least one distributed ledger.

FIG. 13: Schematically shows, in an activity diagram, additional details about the interactions among the trusted protagonist and the at least one engaged antagonist that during the negotiation phase found an agreement, focusing on the utilization of at least one contract model selected from at least one contract models repository enriched if on the basis of the converged negotiation an upgrade is required.

FIG. 14: Schematically shows, in a block diagram, the main components of the method and system for the handling of distributed ledger objects among trusted agents through computational argumentation and inference in the interest of their managers wherein in an embodiment of the present invention at least one agent is a human and at least one agent is not a human and the latter performs the distributed ledger objects valorisation phase if the trusted protagonist and at least one of the engaged antagonists subscribe at least one distributed ledger objects handling contract.

### DETAILED DESCRIPTION

The present invention applies in integrated way distributed ledger technology, computational argumentation and inference, vocal argumentation and root of trust based security.

In the following description the term manager 2 is referred to an entity comprising means to define and activate some claims with their constraints and limits. A claim or issue is a statement essentially arguable but used as a primary point to support or prove an argument. Argumentation is, in fact, a discourse in which a set of propositions is put forward to justify the acceptance of a questioned proposition—the standpoint or claim. Claims are the main components of an argument; identifying and using them correctly are essential to framing an argument in a debate. Whereas formal arguments are static, such as one might find in a textbook or research article, argumentative dialogue is dynamic. It serves as a published record of justification for an assertion.

In the following description the term agent, acting as protagonist 1 or antagonist 3, is referred to an entity comprising means to accept in input claims from a manager 2 with their constraints and limits and to manage their finalization by interacting with other agents to find an agreement on the handling of distributed ledger objects.

For exemplificative purpose and without limiting the scope of the present invention a manager 2 or an agent, protagonist 1 or antagonist 3, can be, indifferently and interchangeably, a silicon-based technology entity like an electronic device such as a wearable device or a smartphone or an IoT device or, in general, a computerized device or robots or it can be a carbon-based entity like a human or an animal. So it is possible that one antagonist agent 3 is human and the protagonist agent 1 is not a human agent or vice versa. The agents can interact also with other trusted or non-trusted entities such as external databases and websites and exchange data with them.

Distributed ledger objects are the building block of “internet of value” and enable recording of interactions and transfer “value” peer-to-peer, without a need for a centrally coordinating entity. “Value” refers to any record of ownership of asset—for example money, securities, land titles—and also ownership of specific information like identity, health information and other personal data. The present invention considers value as the monetary worth of something: market price, a fair return or equivalent in goods, services, or money for something exchanged, a relative worth, utility, or importance, something (such as a principle or quality) intrinsically valuable or desirable (sought material values instead of human values), a numerical quantity that is assigned or is determined by calculation or measurement, an act of denominating, a value or size of a series of values or sizes, congregations united in their adherence to its beliefs and practices. Distributed ledger object is a digital value created from code, managed and monitored by a peer to peer internet protocol and encrypted in a string of data or hash, encoded to signify one value unit.

The present invention guarantees traceability, reliability, availability, serviceability and consistency of data organization through distributed ledger methodology and systems application; advanced and innovative reasoning and inference capacity through computational argumentation and inference; high security and safety levels of system usage through root of trust and cryptographic secrets, biometrics and argumentative human behaviour identity solutions.

The present invention emphasizes the ultimate human being centrality in relation with available technology, focusing the user needs and respecting the language, logic, inference, reasoning, emotion and argumentation of the human natural behaviour.

In the present invention the distributed ledger technology, as system distributed on different computerized nodes, is applied to manage the result of the agreement among the agents, both static data (registry) and dynamic data (transactions), by replicating and saving a copy of the ledger. The basic principle of consensus through agents voting is widely applied. A consensus is an argumentation and inference based algorithm that, once solved, automatically updates the system distributed on all nodes. The present invention permits to utilize distributed ledgers in public, private and hybrid modes, depending on each specific application needs. The system is open to permission-less and permissioned, private and public combination modes.

An embodiment of the present invention requires an intensive computational argumentation usage, integrated with computational inference. Computational inference primarily allows to solve associative problems and computational argumentation cause/effect problems, so that jointly improve the inferencing and reasoning capacities to obtain an added semantic, meaning-driven value. The invention permits to automatically apply the alternative approaches analysing the content and the structure of each claim and establishing if is more inference or argument based.

Given that the most relevant human interaction is analogically vocal and argumentation driven, the present invention focuses on the argumentation driven vocal dialogue. So, this invention is also characterized by the innovative utilization of vocal computational argumentation not only as a relevant part of arguments inception, engagement and negotiation but also on identity behaviour to meet the argumentative personality who in verbal sparring matches engagement. Vocal argumentation is a very innovative way to obtain a stable perception of person identity from vocal cues.

For the security required to authenticate managers and agents and to provide controlled access to the system, an embodiment of the present invention requires the innovative application of root of trusts and biometric security mechanism, based on the automatic and instant verification of an individual's physical characteristics, integrated with vocal computational argumentation and inference solutions, in which the specific argumentation behaviour of each person is analysed and used to help the identification.

The system can be used as the tool for a manager using at least one agent with its given knowledgebase, in a monological process of listing arguments and counterarguments that can be used to evaluate a situation.

Hereinafter are described the components according on the system of present invention, the phases according on the method of the present invention and, in the conclusion, the industrial applicability is emphasised.

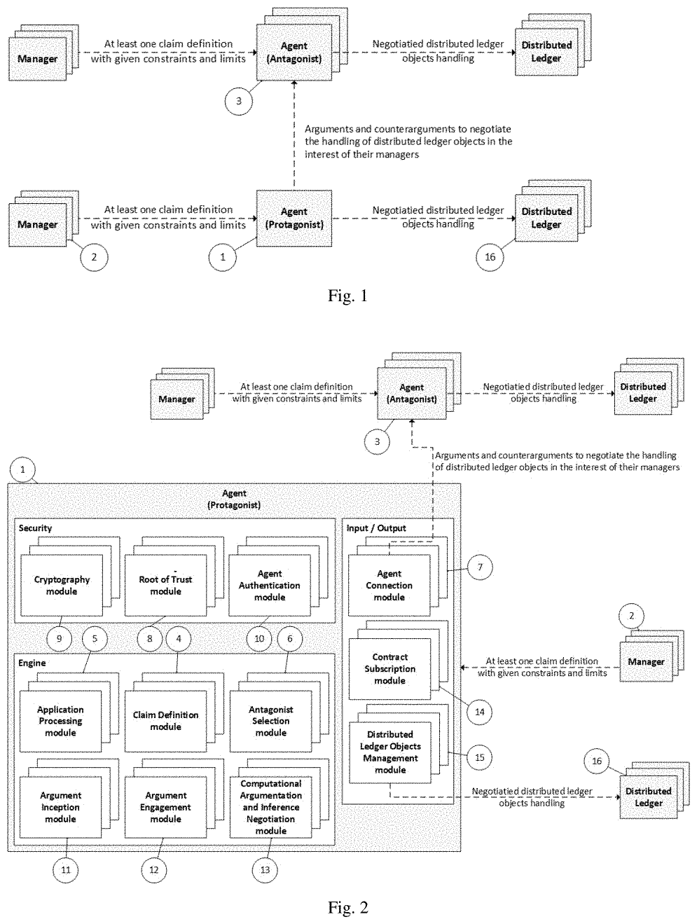

The present invention, with reference to FIG. 1, provides a method and system for the handling of distributed ledger objects among trusted agents through computational argumentation and inference in the interest of their managers, whereto an agent, the protagonist 1, unequivocally associated to at least one manager 2, initiates a dialogue with other agents, the antagonists 3, by means of at least one argument to justify the acceptance of at least one claim aiming to obtain the handling of distributed ledger objects in the interest of its at least one manager 2, negotiates with the antagonists 3 by generating and exchanging arguments and counterarguments and finalizes the handling of objects in at least one distributed ledger 16 if the negotiation converges to the handling of distributed ledger objects acceptable by the protagonist 1 and the antagonists 3 on the basis of their claims and within their given constraints and limits. The protagonist 1 is the trusted agent that initiates and operates as proactive counterpart of an interaction while the antagonist 3 is the trusted agent that reacts to the action of protagonist 1 and during the claiming process could become an engaged antagonist.

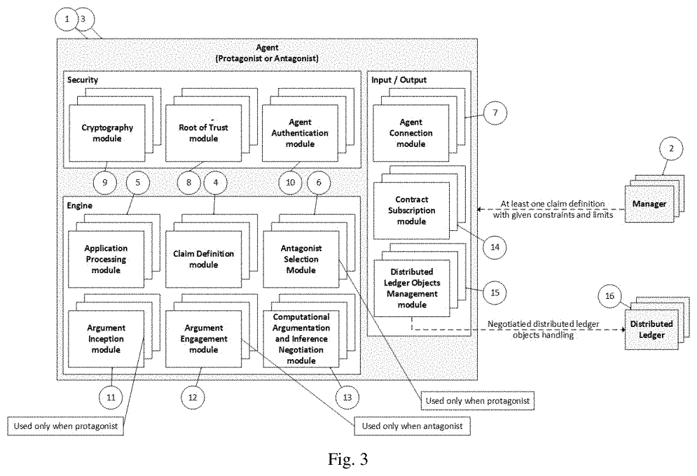

According to the present invention and with reference to FIG. 2 or FIG. 3, an agent comprises the following modules.

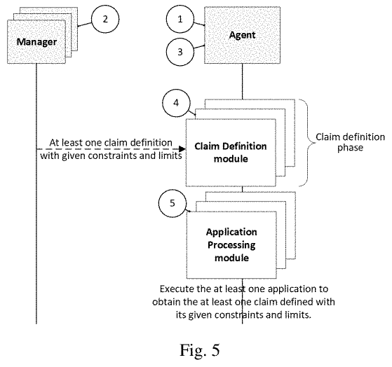

At least one claim definition module 4 to handle a claim definition phase in which each agent is configured for the handling of distributed ledger objects to obtain, with given constraints and limits, at least one claim defined in the interest of its at least one manager 2. The claim definition phase, with reference to FIG. 5, is initiated by the agent's at least one manager 2 to describe some aspect of reality with the common goal to solve a problem.

At least one application processing module 5 to process at least one application to obtain the at least one claim defined with its given constraints and limits. The at least one application, with reference to FIG. 5, is executed immediately after the claim definition phase.

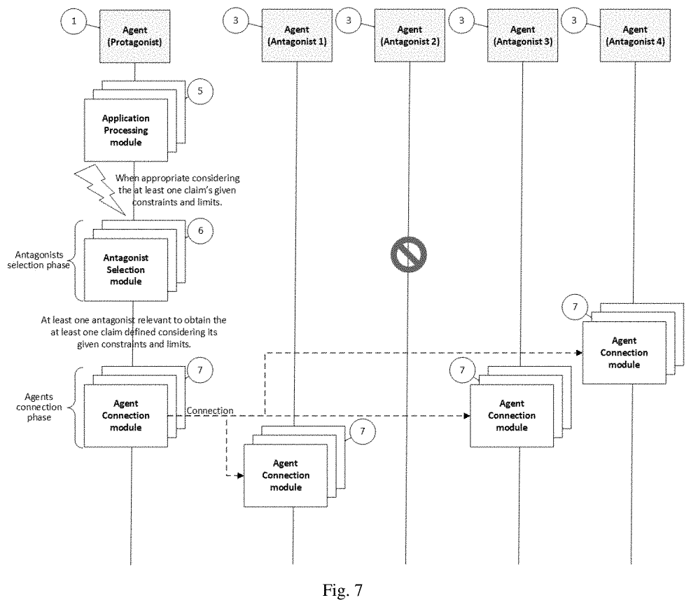

At least one antagonist selection module 6 to handle an antagonists selection phase in which the protagonist 1 selects at least one antagonist 3 relevant to obtain the at least one claim defined when appropriate considering its given constraints and limits. The antagonists selection phase, with reference to FIG. 7, is initiated by the application processing module 5 on the basis of the at least one application in execution so the application processing module 5 triggers the claiming process. If not even a single antagonist 3 is suitable to be selected the claiming process is aborted. According with the present invention, it is worth to point out that the information about the antagonists to be selected, including their characteristics (like identity, connection capabilities, latitude/longitude, business domain, working hours and so on) and known or presumed or inferred claims possibly with given constraints and limits, could be stored by the agent or it could be discovered in or retrieved from external directories or repositories. It is also worth to point out that the information about the antagonist to be selected could be continuously updated by the agents involved in claiming processes or by other actors managing the agents repositories or directories.

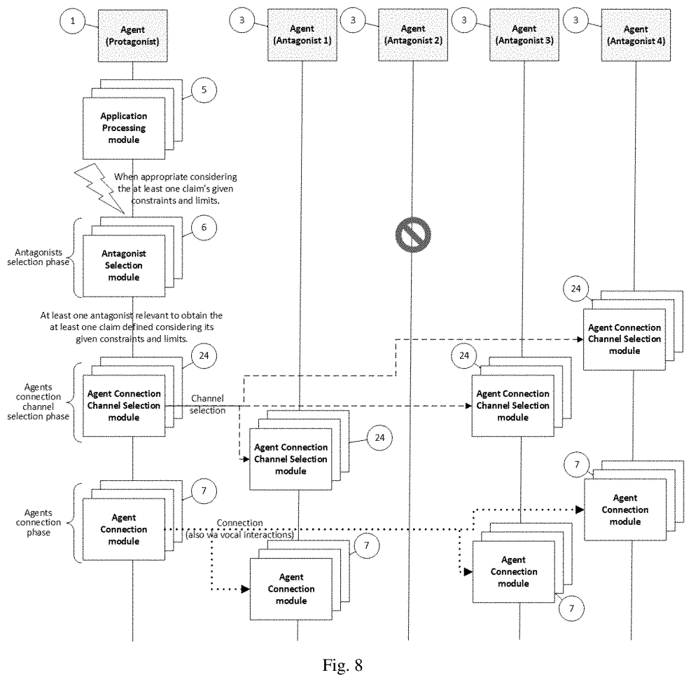

At least one agent connection module 7 to handle an agents connection phase in which the protagonist 1 and the at least one selected antagonist 3 establish a connection. The agents connection phase, with reference to FIG. 7, is initiated by the protagonist's 1 agent connection module 7 attempting a connection to all the selected antagonists 3 by contacting their agent connection modules 7. If it is not possible to establish a connection with not even a single selected antagonist 3 the claiming process is aborted. The connection among the agents, once established, is maintained by them for all the claiming process or until they decide to abandon it or until they are excluded from it. In case of disconnection for technical reasons each agent may perform an attempt to reconnect but the others agents are not forced to wait for it, so they may continue with the claiming process or abort it. According to the present invention and with reference to FIG. 8, it is possible that the at least one agent connection module 7 comprises means to manage a connection among the agents performed via vocal interactions.

At least one root of trust module 8 comprising means to generate and protect keys within its secure environment allowing the secure and unique identification of an agent.

At least one cryptography module 9 to derive cryptographic secrets from the at least one root of trust module 8 and to perform cryptographic functions like data encryption and decryption, sensitive data secure storage and retrieval, digital signatures generation and verification, true random number generation to ensure the maximum security, secure counters to protect against replay attacks and digital certificates management.

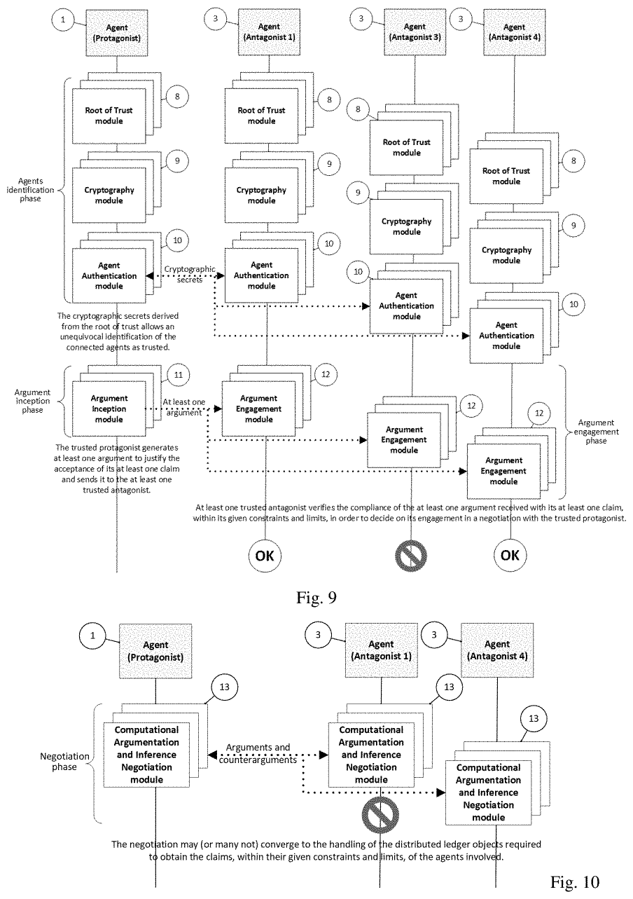

At least one agent authentication module 10 to handle an agents identification phase in which the cryptographic secrets derived from each agent's at least one root of trust module 8 via the at least one cryptography module 9 are exchanged among the connected agents allowing an unequivocal identification of them as trusted. The agents identification phase, with reference to FIG. 9, is initiated by any one of the connected agents in order to trust each other. If it is not possible to unequivocally identify a connected agent, any connection to it is stopped and it is excluded from the claiming process. If the protagonist can't be unequivocally identified by anyone of the connected antagonists or if not even a single connected antagonist can be unequivocally identified by the protagonist, the claiming process is aborted.

At least one argument inception module 11 to handle an argument inception phase in which the trusted protagonist generates at least one argument to justify the acceptance of its at least one claim and sends it to the at least one trusted antagonist. An argument inception could be made of a set of claims starting from premises. The protagonist engages with argumentation to defend its claims and to persuade the antagonists to agree with them. It is worth to point out that this can be done in a huge variety of social interactions pertaining many contexts.

At least one argument engagement module 12 to handle an argument engagement phase in which the at least one trusted antagonist verifies the compliance of the trusted protagonist's at least one argument with its at least one claim within its given constraints and limits in order to decide on its engagement in a negotiation with the trusted protagonist. The engagement is concretized when the premises (which are claims) can produce a valid conclusion (which is another claim). Arguments can also be interactive, in which the protagonist 1 and the antagonist 3 have a more symmetrical relationship. In the most symmetrical case, argumentative dialogue can be regarded as a process of discovery more than one of justification of a conclusion. Ideally, the goal of argumentative dialogue is for participants to arrive jointly at a conclusion by mutually accepted inferences. With the argument engagement module agents are aimed in the evaluation of possible conclusions/claims by considering reasons (arguments and counter-arguments) for and against them, providing a support for and against the conclusions/claims, through a mixture of dialectical and logical reasoning. In argumentative dialogue, the rules of interaction are negotiated by the agents, although in many cases the rules are already determined by social mores. The argument inception phase, with reference to FIG. 9, is initiated by the trusted protagonist's argument inception module 11 and it triggers the at least one argument engagement module 12 of the trusted antagonists to perform the argument engagement phase. If a trusted antagonist decides to not engage in a negotiation with the trusted protagonist, it abandons the claiming process and it stops any connection to any agents involved in the considered claiming process. If not even a single trusted antagonist decides to engage in a negotiation with the trusted protagonist the claiming process is aborted.

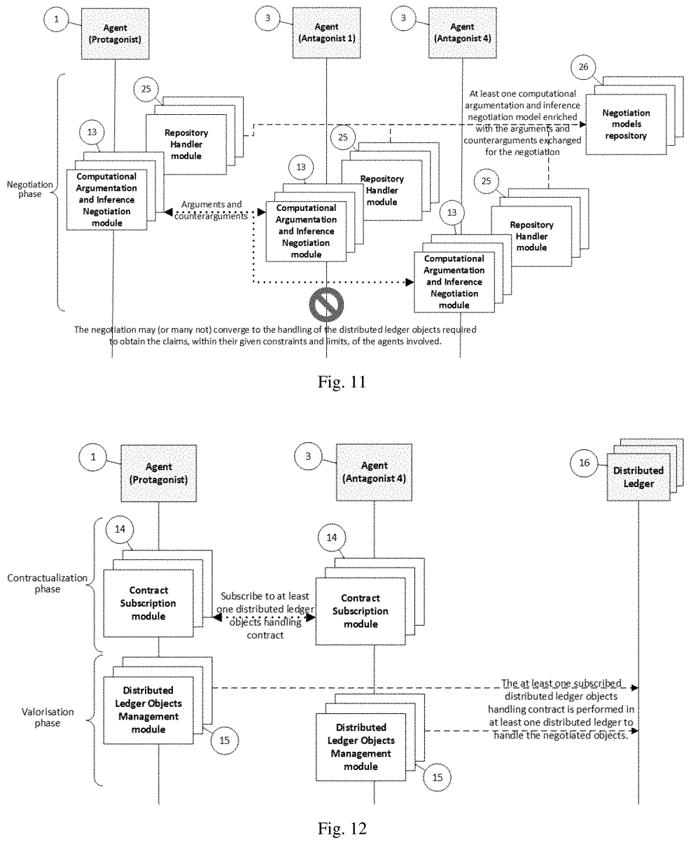

At least one computational argumentation and inference negotiation module 13 to handle a negotiation phase in which the trusted protagonist and the at least one engaged antagonist, through computational argumentation and inference, generate and exchange arguments and counterarguments in order to negotiate the handling of the distributed ledger objects required to obtain their claims within their given constraints and limits. The negotiation phase, with reference to FIG. 10, is initiated by any one of the engaged agents and performed by their computational argumentation and inference negotiation modules 13. It is worth to point out that the negotiation phase may or may not converge to an agreement among the protagonist and at least one of the engaged antagonists. If an engaged antagonist is not able to find an agreement with the protagonist, it abandons the claiming process and it stops any connection to any agents involved in the considered claiming process. If not even a single engaged antagonist is able to find an agreement with the protagonist, the claiming process is aborted. According to the present invention and with reference to FIG. 11, it is possible that the at least one computational argumentation and inference negotiation module 13 comprises means to use at least one computational argumentation and inference negotiation model selected from at least one negotiation models repository 26 and to enrich it with the arguments and counterarguments exchanged for the negotiation among the trusted protagonist and the at least one engaged antagonist. So, it is possible that the computational argumentation and inference negotiation module 13 performs the negotiation phase using computational argumentation and inference and using knowledge models available in the at least one negotiation models repository 26 that could be stored by the agent or that could be discovered in or retrieved from external directories or repositories. It is also worth to point out that those negotiation models, based on sets of arguments and counterarguments exchanged for the negotiations, could be continuously updated by the agents or by other actors managing the agents repositories or directories.

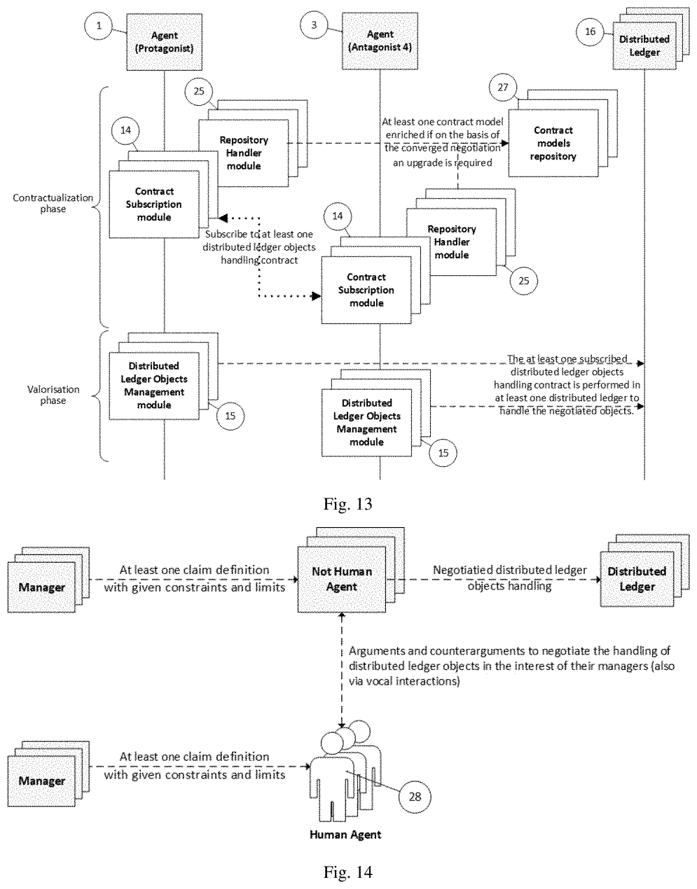

At least one contract subscription module 14 to handle a contractualization phase in which the trusted protagonist and at least one of the engaged antagonists subscribe to at least one distributed ledger objects handling contract if the negotiation phase converges to the handling of distributed ledger objects acceptable by them. The contractualization phase, with reference to FIG. 12, is initiated by any one of the engaged agents that during the negotiation phase found an agreement with the protagonist and performed by their contract subscription modules 14. If an engaged antagonist is not able to subscribe to the at least one distributed ledger objects handling contract, it abandons the claiming process and it stops any connection to any agents involved in the considered claiming process. If not even a single engaged antagonist is able to subscribe to the at least one distributed ledger objects handling contract, the claiming process is aborted. According to the present invention and with reference to FIG. 13, it is possible that the at least one contract subscription module 14 comprises means to use at least one contract model selected from at least one contract models repository 27 and to enrich it if the converged negotiation phase requires its upgrade. So, it is possible that the contract subscription module 14 performs the contractualization phase using contract models available in the at least one contract models repository 27 that could be stored by the agent or that could be discovered in or retrieved from external directories or repositories. The contract model repository 27 could be a set of updatable distributed ledger objects handling contract templates models; each model is a computer protocol intended to digitally facilitate, verify, or enforce the negotiation or performance of a contract, allowing the performance of credible transactions without external third parties involvement. The distributed ledger objects handling contracts may have many kinds of contractual clauses and they may be made partially or fully self-executing, self-enforcing, or both. The aim of distributed ledger objects handling contracts is to provide security that is superior to traditional contract law and to reduce other transaction costs associated with contracting. In fact, the transactions generated by them are trackable and irreversible. It is also worth to point out that those contract models could be continuously updated by the agents or by other actors managing the agents repositories or directories.

At least one distributed ledger objects management module 15 to handle a distributed ledger objects valorisation phase in which the at least one subscribed distributed ledger objects handling contract is performed in at least one distributed ledger 16 to handle the negotiated objects. A distributed ledger object may manage the managers, agents, arguments and contracts data. The valorisation phase, with reference to FIG. 12, is initiated by any one of the engaged agents that during the negotiation phase found an agreement with the protagonist and performed by their contract subscription modules 14.

If the initiator of a valorisation phase is a trusted antagonist, the trusted protagonist is able to detect the outcome of such valorisation phase, either explicitly or implicitly. An outcome of a valorisation phase can be a debit or credit registration on a credit card, the opening of a door or any other access restriction means, the signalling of a wellness program completed, the confirmation of the registration of an insurance contract, or the confirmation of the delivery of a mass-customized product or any other form of outcome of a valorisation phase.

If not even a single engaged antagonist is able to perform the at least one subscribed distributed ledger objects handling contract in at least one distributed ledger 16, the claiming process is aborted.

The fact that the claiming process is aborted may, according to the circumstances, trigger an alarm, or may issue an abort notification or take any other action in the interest of the safety of the agents.

According with the present invention and with reference to FIG. 3, it is worth to point out that the protagonist 1 and the antagonist 3 agents could comprise the same set of modules but when acting as protagonist 1 the agent doesn't make use of the argument engagement module 12 while when acting as antagonist 3 the agent doesn't make use of the antagonist selection 6 and the argument inception 11 modules. The same agent may act in some cases as protagonist 1 and in some other cases as antagonist 3 depending on the at least one application executing on the application processing module 5 aiming to obtain the at least one claim defined with its given constraints and limits.

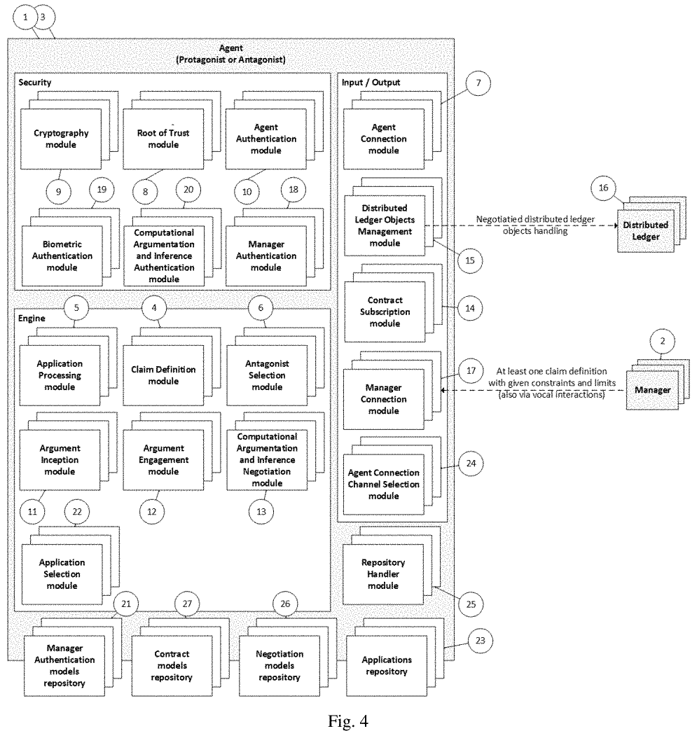

According to the present invention and with reference to FIG. 4, it is possible that an agent comprises the following additional modules.

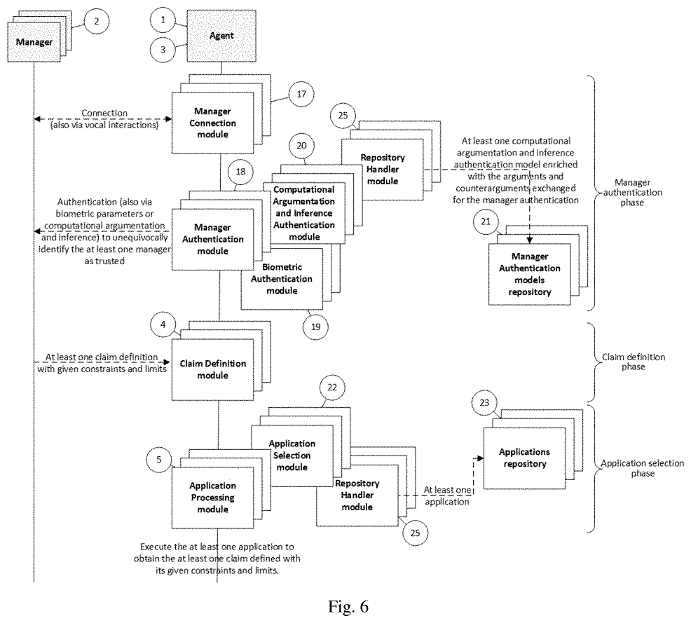

At least one manager connection module 17 to handle a connection with the agent's at least one manager 2 through which the agent is configured during the claim definition phase. This connection, with reference to FIG. 6, can be initiated by the at least one manager or by the at least one agent's manager connection module 17. According to the present invention it is possible that the at least one manager connection module 17 comprises means to manage vocal interactions and so the connection between the agent and its at least one manager could be a vocal interaction.

At least one manager authentication module 18 to handle a manager authentication phase allowing an unequivocal identification of the agent's at least one manager 2 as trusted. According to the present invention and with reference to FIG. 6, it is possible that the manager authentication module 18 comprises means to initiate the manager authentication phase. The application of computational and argumentation inference in contract research and update is useful not only to consider some foundational topics such as terminology, automation, enforceability, and semantics of contract models but also to define the specific single contract, covering both operational and non-operational aspects and describe templates and agreements based on legal documents and on demand/offer pricing relationships. With computational argumentation and inference is possible to identify operational parameters in the legal documents and use these to connect legal agreements with design landscape, including increasing sophistication of parameters, increasing use of common standardised code and marketing and behaviour research.

At least one biometrics authentication module 19 to authenticate the agent's at least one manager through biometrics parameters. According to the present invention and with reference to FIG. 6, it is possible that the biometrics authentication module 19 implements protocols, based on cryptographic keys derived from distinctive and measurable physiological or behavioural biometrics characteristics, to unequivocally identify the agent's at least one manager in case it is a human.

At least one computational argumentation and inference authentication module 20 to authenticate the agent's at least one manager through computational argumentation and inference using at least one computational argumentation and inference authentication model selected from at least one manager authentication models repository 21 enriched with the arguments and counterarguments exchanged for the manager authentication. According to the present invention and with reference to FIG. 6, it is possible that the computational argumentation and inference authentication module 20 implements protocols, based on computational argumentation and inference and using knowledge models available in the at least one manager authentication models repository 21 that could be stored by the agent or that could be discovered in or retrieved from external directories or repositories, to unequivocally identify the agent's at least one manager. The manager authentication models repository 21 contains a set of authentication models based for instance on the managers characteristics and behaviour. It is worth to point out that those manager authentication models could be continuously updated by the agents or by other actors managing the agents repositories or directories.

It is worth to point out that the cybersecurity concepts are pervasive in the present invention as it is covering all of its parts. The unequivocal association, the connection and the authentication among managers and agents and among agents is guaranteed by the security provided by root of trusts and cryptographic secrets derived from them, biometrics secrets and argumentative human peculiarities uniqueness.

At least one application selection module 22 to handle an application selection phase to select from at least one applications repository 23 the at least one application to be used by the at least one application processing module 5 to obtain the at least one claim defined with its given constraints and limits. According to the present invention and with reference to FIG. 6, it is possible that the agent's at least one application selection module 22 initiates the application selection phase considering applications available in the at least one applications repository 23 that could be stored by the agent or that could be discovered in or retrieved from external directories or repositories. The application repository 23 could be an application container, providing access to a plurality of software applications, that may include a set of executable applications and a set of associated system files required to execute them like runtime components, such as files, environment variables and libraries, necessary to run the desired software. It is worth to point out that the applications used by the agents could be continuously updated by the agents or by other actors managing the agents repositories or directories.

At least one agent connection channel selection module 24 to handle an agents connection channel selection phase in which the protagonist 1 agrees with the at least one selected antagonist 3 the channel to be used for the connection. According to the present invention and with reference to FIG. 8, it is possible that the protagonist's at least one agent connection channel selection module 24 initiates the agents connection channel selection phase in order to find the channel and protocols more suitable to establish a connection among the involved agents. It is worth to point out that it is possible that the at least one agent connection channel selection module 24 comprises means to perform the channel selection by using at least one signalling channel predefined and shared among the agents or by attempting a discovery over multiple channels (like but not limited to the ones defined by IEEE 802.11, IEEE 802.15 or 3GPP standards or the voice) in a parallel or sequential way.

At least one repository handler module 25 to provide access to and to manage the at least one repository used by the agent. So, it is possible that, with reference to FIG. 6, the repository handler module 25 comprises means to provide the computational argumentation and inference authentication module 20 with the possibility to access and manage the manager authentication models repository 21. Similarly, it is possible that, with reference to FIG. 6, the repository handler module 25 comprises means to provide the application selection module 22 with the possibility to access and manage the applications repository 23. Likewise, it is possible that, with reference to FIG. 11, the repository handler module 25 comprises means to provide the computational argumentation and inference negotiation module 13 with the possibility to access and manage the negotiation models repository 26. Finally, it is possible that, with reference to FIG. 13, the repository handler module 25 comprises means to provide the contract subscription module 14 with the possibility to access and manage the contract models repository 27.

According to the present invention and with reference to FIG. 14, it is possible that at least one agent is a human 28 and at least one agent is not a human. It is worth to point out that, in this case, the at least one not human agent performs the distributed ledger objects valorisation phase if the trusted protagonist and at least one of the engaged antagonists subscribe at least one distributed ledger objects handling contract. In fact, in a particular embodiment of the present invention, to make easier for individuals and businesses to outsource their processes and jobs to a distributed workforce who can perform these tasks virtually and wherein one agent is human and the other agent is not a human agent and if the trusted protagonist and the engaged antagonists subscribe at least one distributed ledger objects handling contract, the non-human agent performs the distributed ledger objects valorisation phase. This distributed ledger objects include anything from conducting simple data validation and research to more subjective tasks like survey participation, content moderation and more. The human agent 28 can take the last decision.

The present invention shows a wide level of invention industrial applicability in the sectors in which high friendly, natural, argumentative and secure relationship between man and machine and machine to machine are necessary and pure computational inference and digital intelligence, traditional data base and security technology are insufficient and inadequate.

The arguments and data contents consistency, security levels and natural argumentation reasoning are merged together to manage transparent and traceable negations and interactions are emerging needs on all industrial sectors.

The present invention is positioned in computer science innovation trends, based on collaborative autonomous technologies, in which intelligent interactive machines, able of computational argumentation and inference functionalities, intermediate and operate in distributed ledger consensus-based value-added generation capacity, collaborating with trusted and authenticated single and multiple interconnected human agents protagonist and antagonist.

In this context, the present invention will be more and more cross-linking applied in the most relevant industry sectors starting from autonomous mobility, to intelligent building and home automation, industry and delivery sectors and fintech sector too. In the perspective, the present invention impacts will be relevant in other industrial sectors as wellness/healthcare, entertainment, media and intellectual property management.

In the autonomous mobility industry, the present invention, thanks to computational argumentation and inference capacity, will contribute in the self-driving functions integrating the inferential environment analysis decision taking algorithms with argumentation-based functions, including cause/effect analysis, emotional computing and ethical based ultimate decision; in this way the autonomous levels will be dramatically empowered first of all in term of safety. With the integrated distributed ledger technology usage, the autonomous mobility will enforce in particular the mobility networking functions and better manage the vehicle movement, charging and maintenance needs and from the passenger and drivers' point of view choses, expectations, behaviors and service levels, vocally interactively argumented. The integrated root of trust represents the fundamental condition to guarantee the vehicle to vehicle and with infrastructure interconnection and the drivers/passenger authentication security.

In building and intelligent home industry, thanks to computational argumentation and inference, the invention will contribute to improve the home technology interaction, vocally argumented driven. Distributed ledger technology can be applied for building management starting from energy management in term of consumption, generation storage and trading and other home utility service starting from water and waste. The smart metering and sub-metering of Internet of Things will be managed by distributed ledger technology. The root of trust technology guarantees home security improvement. With the integrated approach it is possible to achieve a sustainable building goal emphasizing the home quality of life, the real estate value and the harmonious placing in the smart environment.

In fintech sector, thanks to computational argumentation and inference, the invention will improve data consistency and decision taking functions in asset management activities, particularly robo-advisory and algorithm pre-programmed High Frequency Trading, in credit management and in payment systems. In asset management is more and more evident the risk to operate with too big computational inference delegation; the reasoning functions of computational argumentation introduce new possibility to avoid dangerous consequences. Also, in credit analysis computational argumentation will be particularly efficient in customer behavior analysis and in payment systems, even if they are essentially mass transaction processes, with computational argumentation it is possible to better manage the growing available modalities. At the date, the most relevant sector in which distributed ledger technology, essentially in Blockchain modality, is applied is fintech but it is evident the necessity to identify new data structure and consensus acquisition modality; the negotiation phases must utilize more argumentation base functions, instead of proof of work techniques. Computational argumentation based and computational inference based financial services, integrated with more efficient distributed ledger technology, furthermore require an improvement of security functions: root of trust with computational argumentation and inference authentication facilities is the necessary answer to avoid the growing fraud risks.

For the wellness industry, as a combination of eating habits, lifestyles, sports and personal care and, in parallel, for managing the aging of the population that brings with it the increase in the incidence of chronic diseases (such as heart disease, diabetes, respiratory disorders), the invention can be an essential enabling factor. The technological evolution of connected objects that measure the state of health, such as clothing and sports related equipment that follows sports activity in real time, applications that support the diet as well as related objects, equipped with real medical applications in times relatively short, strives to provide overall management of the person's health. To achieve this goal, a new business model and the availability of an integrated enabling platform is needed. Computational argumentation permits a better knowledge of personal profile. Distributed ledger technology allows to design an open model that follows the entire life cycle of the person, his lifestyle, his medical record, pharmaceutical plan and medicine program as well as the connection with open platforms for the collection and management of data that come from very different devices and that require ad hoc certifications. It is possible an innovative approach of communities that are created around wearable devices or apps with agreements that envisage developing cover proposals and personalized services in exchange for the possibility to access participants' data. Root of trust allows to develop greater maturity and awareness in information security, designing processes and models to minimize the risks on the one hand of unauthorized access (cybercrime) and on the other hand of improper or non-use comply with personal data. Through the present invention, insurers have the opportunity to innovate their offer both in health management and in mobility sectors. In the health sector, by promoting the culture of prevention and a healthy lifestyle as a positive factor on the health of the insured, insurances can act primarily on the reduction of claims and then the possibility of expanding their market to chronic subjects or at risk, customizing products and services based on best observable behavior.

The insurance companies have the opportunity to expand the range of services offered, from assistance in case of need to teleconsultation and, to tend, to tele-diagnosis. Develop ad hoc coverage for individuals with chronic diseases, pushing on the adoption of technology as an element of risk mitigation in terms of prevention and monitoring of therapy, in collaboration with public and private health structures. Thanks to the application of the invention, insurances therefore have a great opportunity to innovate their health offer, provided they focus on listening and analyzing customer needs, bringing to the market a concrete response to a widespread need of customers: to be followed, supported and helped in the management of one's own health, too often neglected due to lack of time and awareness of the risks. Also in the automotive sector the emerging challenge concerns in particular the autonomous mobility that causes various problems and insurance opportunities.

In this context, the integrated application of distributed leger technology, of computational argumentation and inference the root of trust security will permit to dramatically change the insurance offer and the customer relationship.

Mass customization and product personalization can provide an answer to the challenges of the mutations of the consumer society, putting companies in the position of moving the competition on grounds that are much more favorable to them than the old ones in which production volumes and low costs seem to matter more than anything else.

Mass production is based on the product life cycle with the design at the beginning done in the factory or production company and then manufacturing and finally in the market (like supermarkets, shops, retailers). But there is never interaction with the final costumer/consumer. Mass customization is based on the product life cycle where the consumer is involved at the beginning during the design phase and, of course, at the end of the cycle that is the sale phase. The interaction with the consumer is essential because the final product must be customized and personalized according to some parameters based on style, fit and comfort. Presently Mass Customization is based on computational inference with a rather rigid interaction between the customer and the producer. The customization is mainly based on the choice selection by the consumer in a table format or cascade of menus. In many cases the human agent is the only valid alternative to determine what the consumer really wants or desire. The invention, activating computational argumentation & inference in the personalization process, allows the configuration of the product in a much more flexible way. The emotional aspects of the selection by a consumer can be understood much better and therefore embedded into the personalized product through an argumentation interaction. It won't be only a matter of interface but the possibility to understand the sentiments and emotions of the user avoiding any anxiety assuring a proper selection process through an argumentation interaction. The requirement collection phase can be expensive because on one hand building a relationship among human beings takes time and it's the base for customer loyalty, but on the other hand advanced technology today assures accuracy of the product. The integration with distributed ledger technology data structure and consensus method will insure that all the personal desires, choices, needs and the product evolution are historically traced and recorded. The relationship and negotiation between the producer and the consumer chain is contractually dynamically managed. Furthermore, the integration of the root of trust will insure that all the confidential information regarding the payments but, more interestingly, the personal profile and identity and product uniqueness are secured.

In the sustainability field, the invention will contribute through computational inference managing the sustainable development goals and the connected targets tables and through computational argumentation analyzing the semantic value of each parameters in the relation with the specific situation to support the standardization needs; the computational argumentation will be relevant in the following phase of the sustainability analysis output application. The distributed ledger technology has to be integrated in these processes to manage the data structure and the consensus among the involved partners in an automatized way. Root of trust is necessary to guarantee adequate level of privacy and sensitive information protection.

We claim:

1. A method for the handling of distributed ledger objects among trusted agents through computational argumentation and inference in the interest of their managers, whereto a protagonist agent, unequivocally associated to at least one manager, initiates a dialogue with at least one antagonist agent, by means of at least one argument to justify the acceptance of at least one claim aiming to obtain the handling of distributed ledger objects in the interest of its at least one manager, the method comprising:
initiating a claim definition phase in which the protagonist agent is configured for the handling of distributed ledger objects to obtain, with given constraints and limits, at least one claim defined in the interest of its at least one manager;
executing at least one application to obtain the at least one claim defined with its given constraints and limits;
initiating an antagonists selection phase in which the protagonist agent selects at least one antagonist agent relevant to obtain the at least one claim defined when appropriate considering its given constraints and limits;
initiating an agents connection phase in which the protagonist agent and the at least one selected antagonist agent establish a connection;
initiating an agents identification phase in which cryptographic secrets derived from each agent at least one root of trust module are exchanged among the connected agents allowing an unequivocal identification of them as trusted;
initiating an argument inception phase in which the trusted protagonist agent generates at least one argument to justify the acceptance of its at least one claim and sends it to the at least one trusted antagonist agent;
performing a negotiation phase in which the trusted protagonist agent, after receiving the output of an argument engagement phase performed by the at least one trusted antagonist agent, generates arguments and counterarguments by means of computational argumentation and inference, in order to negotiate, with the at least one engaged trusted antagonist agent, the handling of distributed ledger objects required to obtain at least one claim;
performing a contractualization phase in which the trusted protagonist agent is configured to subscribe to at least one distributed ledger objects handling contract with at least one of the engaged trusted antagonist agents if the negotiation phase converges to the handling of acceptable distributed ledger objects;
performing or detecting the outcome of a distributed ledger objects valorisation phase in which the at least one subscribed distributed ledger objects handling contract is performed in at least one distributed ledger to handle the negotiated objects.

2. The method according to claim 1, wherein each antagonist agent has the same capabilities of a protagonist agent and, when it is involved in an argument inception phase as trusted antagonist, performs an argument engagement phase in which it verifies the compliance of the trusted protagonist agent's at least one argument with its at least one claim, within its given constraints and limits, in order to decide on its engagement in a negotiation with the trusted protagonist agent.

3. The method according to claim 2, wherein an agent, during the claim definition phase, is configured through a connection with its at least one manager.

4. The method according to claim 3, wherein the connection between the agent and its at least one manager is a vocal interaction.

5. The method according to claim 3, wherein the agent initiates a manager authentication phase to allow an unequivocal identification of its at least one manager as trusted.

6. The method according to claim 5, wherein the agent's at least one manager is authenticated through biometrics parameters.

7. The method according to claim 5, wherein the agent's at least one manager is authenticated through computational argumentation and inference using at least one computational argumentation and inference authentication model selected from at least one manager authentication models repository enriched with the arguments and counterarguments exchanged for the manager authentication.

8. The method according to claim 2, wherein an agent initiates an application selection phase to select from at least one applications repository the at least one application to be used to obtain the at least one claim defined with its given constraints and limits.

9. The method according to claim 1, wherein the protagonist agent initiates an agents connection channel selection phase in order to agree with the at least one selected antagonist agent the channel to be used for the connection.

10. The method according to claim 1, wherein the connection among the agents is a vocal interaction.

11. The method according to claim 2, wherein the negotiation phase is performed using at least one computational argumentation and inference negotiation model selected from at least one negotiation models repository enriched with the arguments and counterarguments exchanged for the negotiation among the trusted protagonist agent and the at least one engaged antagonist agent.

12. The method according to claim 2, wherein the contractualization phase is performed using at least one contract model selected from at least one contract models repository enriched if the converged negotiation phase requires the upgrade of the at least one contract model selected.

13. A system for the handling of distributed ledger objects among trusted agents through computational argumentation and inference in the interest of their managers, whereto a protagonist agent, unequivocally associated to at least one manager, is adapted to initiate a dialogue with antagonist agents, by means of at least one argument to justify the acceptance of at least one claim aiming to obtain the handling of distributed ledger objects in the interest of its at least one manager, and it is adapted to negotiate with the antagonist agents by generating and exchanging arguments and counterarguments and to finalize the handling of objects in at least one distributed ledger if the negotiation converges to the handling of distributed ledger objects acceptable by the protagonist agent and the antagonist agents on the basis of their claims and within their given constraints and limits, the protagonist agent comprising:
at least one claim definition module adapted to handle a claim definition phase in which the protagonist agent is configured for the handling of distributed ledger objects to obtain, with given constraints and limits, at least one claim defined in the interest of its at least one manager;
at least one application processing module adapted to process at least one application to obtain the at least one claim defined with its given constraints and limits;
at least one antagonist selection module adapted to handle an antagonists selection phase in which the protagonist agent selects at least one antagonist agent relevant to obtain the at least one claim defined when appropriate considering its given constraints and limits;
at least one agent connection module adapted to handle an agents connection phase in which the protagonist agent and the at least one selected antagonist agent establish a connection;
at least one root of trust module;
at least one cryptography module adapted to derive cryptographic secrets from the at least one root of trust module;
at least one agent authentication module adapted to handle an agents identification phase in which the cryptographic secrets derived from each agent's at least one root of trust module via the at least one cryptography module are exchanged among the connected agents allowing an unequivocal identification of them as trusted;
at least one argument inception module adapted to handle an argument inception phase in which the trusted protagonist agent generates at least one argument to justify the acceptance of its at least one claim and sends it to the at least one trusted antagonist agent;
at least one computational argumentation and inference negotiation module adapted to handle a negotiation phase in which the trusted protagonist agent, after receiving the output of an argument engagement module operated by the at least one trusted antagonist agent, generates arguments and counterargument by means of computational argumentation and inference, in order to negotiate, with the at least one engaged trusted antagonist agent, the handling of distributed ledger objects required to obtain at least one claim;
at least one contract subscription module adapted to handle a contractualization phase in which the trusted protagonist agent cooperates with at least one of the engaged trusted antagonist agents to subscribe to at least one distributed ledger objects handling contract if the negotiation phase converges to the handling of acceptable distributed ledger objects;
at least one distributed ledger objects management module adapted to handle or detect the outcome of a distributed ledger objects valorisation phase in which the at least one subscribed distributed ledger objects handling contract is performed in at least one distributed ledger to handle the negotiated objects.

14. The system according to claim 13, wherein each antagonist agent comprises the same modules of a protagonist agent and at least one argument engagement module adapted to handle, when it is involved in an argument inception phase as trusted antagonist, an argument engagement phase in which it verifies the compliance of the trusted protagonist's at least one argument with its at least one claim, within its given constraints and limits, in order to decide on its engagement in a negotiation with the trusted protagonist agent.

15. The system according to claim 14, wherein an agent comprises at least one manager connection module adapted to handle a connection with its at least one manager.

16. The system according to claim 15, wherein the at least one manager connection module comprises means to manage vocal interactions.

17. The system according to claim 15, wherein the agent comprises at least one manager authentication module adapted to handle a manager authentication phase allowing an unequivocal identification of its at least one manager as trusted.

18. The system according to claim 17, wherein the agent comprises at least one biometrics authentication module to authenticate its at least one manager through biometrics parameters.

19. The system according to claim 17, wherein the agent comprises at least one computational argumentation and inference authentication module adapted to authenticate its at least one manager through computational argumentation and inference using at least one computational argumentation and inference authentication model selected from at least one manager authentication models repository enriched with the arguments and counterarguments exchanged for the manager authentication.

20. The system according to claim 14, wherein an agent comprises at least one application selection module adapted to handle an application selection phase to select from at least one applications repository the at least one application to be used to obtain the at least one claim defined with its given constraints and limits.

21. The system according to claim 14, wherein an agent comprises at least one agent connection channel selection module adapted to handle an agents connection channel selection phase in which the protagonist agent agrees with the at least one selected antagonist agent the channel to be used for the connection.

22. The system according to claim 13, wherein the at least one agent connection module comprises means to manage vocal interactions.

23. The system according to claim 14, wherein the at least one computational argumentation and inference negotiation module comprises means to use at least one computational argumentation and inference negotiation model selected from at least one negotiation models repository and to enrich it with the arguments and counterarguments exchanged for the negotiation among the trusted protagonist agent and the at least one engaged antagonist agent.

24. The system according to claim 14, wherein the at least one contract subscription module comprises means to use at least one contract model selected from at least one contract models repository and to enrich it if the converged negotiation phase requires its upgrade.

25. The system according to claim 14, wherein an agent comprises at least one repository handler module adapted to provide access to and to manage at least one manager authentication models repository or at least one applications repository or at least one negotiation models repository or at least one contract models repository used by the agent.

26. The system according to claim 14, wherein at least one of the agents involved is not a human and its at least one distributed ledger objects management module handles the distributed ledger objects valorisation phase if the trusted protagonist agent and at least one of the engaged trusted antagonist agents subscribe at least one distributed ledger objects handling contract.
